(19) United States
(12) Patent Application Publication
(10) Pub. No.: US 2023/0289139 A1
(43) Pub. Date: Sep. 14, 2023

(54) HARDWARE DEVICE TO EXECUTE INSTRUCTION TO CONVERT INPUT VALUE FROM ONE DATA FORMAT TO ANOTHER DATA FORMAT

(71) Applicant: INTERNATIONAL BUSINESS MACHINES CORPORATION, Armonk, NY (US)

(72) Inventors: Kerstin Claudia SCHELM, Stuttgart (DE); Petra LEBER, Ehningen (DE); Michael KLEIN, Schoenaich (DE); Stefan PAYER, Stuttgart (DE); Cedric LICHTENAU, Stuttgart (DE); Silvia Melitta MUELLER, St. Ingbert (DE)

(21) Appl. No.: 17/653,961

(22) Filed: Mar. 8, 2022

(51) Int. Cl. G06F 7/483

(52) U.S. Cl. CPC G06F 7/483

(57) ABSTRACT

A hardware device is provided to perform a plurality of operations to convert an input value directly from one format to another format. The hardware device is to perform the plurality of operations based on execution of an instruction. The plurality of operations includes converting one part of the input value to provide a converted value, performing one or more arithmetic operations on another part of the input value to provide an intermediate value, and using the converted value and the intermediate value to provide a converted result in the other format. The converting, the performing and the using are performed as part of executing the instruction. The converted result in the other format is to be used in processing within the computing environment.

### BACKGROUND

One or more aspects relate, in general, to facilitating processing within a computing environment, and in particular, to improving such processing.

Applications executing within a computing environment provide many operations used by numerous types of technologies, including but not limited to, engineering, manufacturing, medical technologies, automotive technologies, computer processing, etc. These applications, written in a programming language, such as COBOL, often perform complex calculations in performing the operations. The calculations include, for instance, power and/or exponentiation functions, which often require conversion of data from one format (e.g., binary coded decimal) to another format (e.g., hexadecimal floating point), and vice versa.

In order for an application to perform the conversion from one format to another format, various steps and instructions are executed. For instance, to convert from binary coded decimal to hexadecimal floating point, an application includes steps/instructions to convert a binary coded decimal number to an integer number, then the integer number is converted to a hexadecimal floating point number. Further, to convert back to binary coded decimal, steps/instructions are used to convert the hexadecimal floating point number to an integer number, and then the integer number to binary coded decimal. Moreover, each of those steps may include sub-steps. This is time-consuming, impacting performance of the computing environment, and affecting availability of computer resources.

### SUMMARY

Shortcomings of the prior art are overcome, and additional advantages are provided through the provision of a computer system for facilitating processing within a computing environment. The computer system includes a hardware device to perform a plurality of operations to convert an input value directly from one format to another format. The hardware device is to perform the plurality of operations based on execution of an instruction. The plurality of operations includes converting one part of the input value to provide a converted value, performing one or more arithmetic operations on another part of the input value to provide an intermediate value, and using the converted value and the intermediate value to provide a converted result in the other format. The converting, the performing the one or more arithmetic operations and the using are to be performed as part of executing the instruction. The converted result in the other format is provided to be used in processing within the computing environment.

By using the hardware device to perform the converting, the performing and the using as part of executing an instruction, performance is improved, and use of system resources is reduced. In one aspect, the input value is converted directly from the one format to the other format within one instruction. That is, the value is converted without use of other instructions (e.g., other architected instructions at the hardware/software interface), including other convert instructions to convert the value into intermediate formats prior to the final format.

In one aspect, the converting and the performing are repeated one or more times on one or more next input values to provide the converted result. A next input value of the one or more next input values is provided based on the performing the one or more arithmetic operations on the other part of a previous input value.

As examples, the one format is a hexadecimal floating point format, and the other format is a binary coded decimal format. Further, in one or more examples, the one part of the input value is an integer part of the input value, and the other part of the input value is a fraction part of the input value.

In one aspect, the hardware device includes a multiplication component to multiply the fraction part by a select value to provide the intermediate value. The multiply is an arithmetic operation of the one or more arithmetic operations performed on the other part of the input value.

Further, in one aspect, the hardware device includes at least one component to perform the converting the one part and to accumulate the one or more decimal integers. The converting includes converting one or more hexadecimal integers of the input value to one or more decimal integers. In one example, the multiply, the converting the one or more hexadecimal integers and the accumulate are performed at least substantially in parallel.

By performing the multiply, the converting the one or more hexadecimal integers and the accumulate at least substantially in parallel, the use of processing cycles is reduced, and processing speed is increased.

Yet further, in one aspect, the hardware device further includes at least one checking component to perform accuracy checking to determine whether the converting the one or more hexadecimal integers and the accumulate are operating correctly. The accuracy checking includes generating a digit-wise residue of one or more converted digits of the one or more hexadecimal integers and accumulating digit-wise residues to obtain an accumulated digit-wise residue value, calculating an accumulated residue value based on the one or more decimal integers obtained using the converting the one or more hexadecimal integers and the accumulate, and comparing the accumulated digit-wise residue value and the accumulated residue value to determine whether the converting the one or more hexadecimal integers and the accumulate are operating correctly.

Accuracy checking, in one or more aspects, may be performed on each loop and ensures proper processing.

In one aspect, the hardware device includes at least one checking component to perform accuracy checking to determine whether the multiply is operating correctly. The accuracy checking includes generating a residue value of the integer part and the fraction part, subtracting a calculated residue of the integer part from the residue value to obtain an intermediate residue value, and multiplying the intermediate residue value by a select residue value to obtain a product. The accuracy checking further includes multiplying the fraction part by the select value to obtain an intermediate fraction value, generating another residue value of a next input, the next input being based on the intermediate fraction value, and comparing the product with the other residue value to determine whether the multiply is operating correctly.

In one aspect, the other part of the input value is split into multiple parts, and the performing the one or more arithmetic operations is performed on the multiple parts. The multiple parts include a fraction part and at least one correction part, the at least one correction part to be used to provide the converted result.

By splitting the fraction part, the input value fits the data path, such that the width of the data path need not be increased, avoiding an increase in costs.

In one aspect, the converting and the performing are repeated one or more times on one or more next input values to provide the converted result. A next input value of the one or more next input values being provided based on the performing the one or more arithmetic operations on at least the fraction part of the multiple parts of a previous input value.

In one aspect, the hardware device includes a multiplication component. The multiplication component includes a feedback path to accumulate one or more correction terms obtained from performing the one or more arithmetic operations on one or more correction parts. The multiplication component includes, for instance, a multiplication tree with the feedback path. The multiplication tree is to multiply a plurality of correction parts with a select value to provide a plurality of correction terms and to accumulate the plurality of correction terms.

By using the multiplication component to multiply the correction parts, additional multiplier cycles are not needed. Further, by using the existing feedback path to perform the accumulation of the correction terms, no additional staging is necessary, providing flexibility.

In one example, the performing the one or more arithmetic operations includes performing a multiply of each multiple part by a select value. Further, the hardware device includes at least one checking component to perform accuracy checking to determine whether the multiply is operating correctly.

By performing accuracy checking, proper processing may be performed.

By using the hardware device to perform the plurality of operations as part of executing an instruction, performance is improved, and use of system resources is reduced. In one aspect, the input value is converted directly from the one format to the other format within one instruction. That is, the value is converted without use of other instructions (e.g., architected instructions at the hardware/software interface), including other convert instructions to convert the value into intermediate formats prior to the final format.

Further, in one or more aspects, the hardware device may be used for other processing, such as binary integer to decimal integer conversion, thereby reducing the use of hardware components, reducing costs, and increasing flexibility.

In one aspect, a hardware device is to perform a plurality of operations to convert an input value directly from one format to another format. The plurality of operations is performed based on execution of an instruction. The plurality of operations includes splitting the input value into, at least, a fraction part and a fraction correction part, and performing arithmetic operations on the fraction part and the fraction correction part to provide a next input value and an updated fraction correction part. The splitting and the performing are repeated at least once to obtain an intermediate converted result, in which the next input value is the input value. The performing arithmetic operations further includes performing an arithmetic operation on one or more previous updated fraction correction parts to provide one or more further updated fraction correction parts. The one or more further updated fraction correction parts and the updated fraction correction part based on a last splitting are accumulated to obtain a correction value. A converted result is generated using the intermediate converted result and the correction value.

By splitting the fraction part, the input value fits the data path, such that the width of the data path need not be increased, avoiding an increase in costs.

In one example, the performing arithmetic operations includes performing a multiply of the fraction part by a select value and at least one multiply of the fraction correction part by the select value of each iteration used to generate the converted result.

Further, in one aspect, at least one checking component of the hardware device is to perform accuracy checking to determine whether the multiply is operating correctly. The accuracy checking includes calculating a residue fraction value based on the fraction part of a current input value and a residue correction value based on a fraction correction part of a previous input value, obtaining an intermediate residue value based on the residue fraction value and the residue correction value, and multiplying the intermediate residue value by a select residue value to obtain a product. The accuracy checking further includes multiplying one portion of the fraction part of the current input value by the select value to obtain a next fraction part of a next input value, determining a select correction term based at least on the fraction part of the current input value, determining another residue value based on a residue of the select correction term and a residue of the next fraction part, and comparing the product with the other residue value to determine whether the multiply is operating correctly.

Accuracy checking, in one or more aspects, may be performed on each loop and ensures proper processing.

By using the hardware device to perform the plurality of operations as part of executing an instruction, performance is improved, and use of system resources is reduced. In one aspect, the input value is converted directly from the one format to the other format within one instruction. That is, the value is converted without use of other instructions (e.g., architected instructions at the hardware/software interface), including other convert instructions to convert the value into intermediate formats prior to the final format.

By using the hardware device to perform the plurality of operations as part of executing an instruction, performance is improved, and use of system resources is reduced. Further, the speed at which conversions are performed is increased without losing precision compared to a software solution.

Computer-implemented methods and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present invention;

FIG. 2 depicts one example of processing to convert a value from one format (e.g., hexadecimal floating point) into another format (e.g., binary coded decimal), in accordance with one or more aspects of the present invention;

FIG. 3 depicts one example of components of a hardware device (e.g., a decimal floating point unit) to perform conversion of a value from one format (e.g., hexadecimal floating point) to another format (e.g., binary coded decimal), in accordance with one or more aspects of the present invention;

FIG. 4A depicts one example of processing to convert a fraction part of an input value to be converted when there is no integer part of the input value, in accordance with one or more aspects of the present invention;

FIG. 4B depicts another example of processing to convert a fraction part of an input value to be converted when there is no integer part of the input value, in accordance with one or more aspects of the present invention;

FIG. 5 depicts one example of a multiplier that may be included in the hardware device, in accordance with one or more aspects of the present invention;

FIG. 6A depicts one example of residue checking for convert and accumulate operations, in accordance with one or more aspects of the present invention;

FIG. 6B depicts one example of residue checking for a multiplication operation, in accordance with one or more aspects of the present invention;

FIG. 6C depicts one example of residue checking for a multiplication operation when there is no integer part of the input value, in accordance with one or more aspects of the present invention;

FIGS. 7A-7D depict one example of a hardware device and operations to be performed by the hardware device to convert an input value in one format to another format, in accordance with one or more aspects of the present invention;

FIGS. 8A-8B depict another example of a hardware device and operations to be performed by the hardware device to convert an input value in one format to another format, in accordance with one or more aspects of the present invention;

FIG. 9A depicts another example of a computing environment to incorporate and/or use one or more aspects of the present invention;

FIG. 9B depicts further details of the memory of FIG. 9A, in accordance with one or more aspects of the present invention;

FIG. 10 depicts one embodiment of a cloud computing environment, in accordance with one or more aspects of the present invention; and

FIG. 11 depicts one example of abstraction model layers, in accordance with one or more aspects of the present invention.

### DETAILED DESCRIPTION

In one or more aspects, a capability is provided to facilitate processing within a computing environment. In one aspect, a single instruction (e.g., a single architected hardware machine instruction at the hardware/software interface) is provided to perform convert and other operations of an input value to convert the input value from one format (e.g., a hexadecimal floating point format) to another format (e.g., a binary coded decimal format). The instruction, referred to herein, for instance, as a Vector Convert Hexadecimal Floating Point to Scaled Decimal instruction, is part of a general-purpose processor instruction set architecture (ISA), which is dispatched by a program on a processor, such as a general-purpose processor. (In another example, the instruction may be part of a special-purpose processor, such as a coprocessor configured for certain functions.)

In one aspect, the single instruction is executed within one hardware device, such as a decimal floating point unit. The decimal floating point unit includes, for example, one or more hardware components, each composed of one or more circuits, to perform operations of the instruction to convert the input value. Although example components of the decimal floating point unit are described herein, the decimal floating point unit (or other hardware device) may include additional, fewer and/or other components to convert the input value.

As part of execution of the single instruction (e.g., the Vector Convert Hexadecimal Floating Point to Scaled Decimal instruction), various operations are performed including converting one part of the input value from one format (e.g., hexadecimal floating point) to another format (e.g., binary coded decimal) to provide a converted value, performing one or more arithmetic operations on another part of the input value to provide an intermediate value and using the converted value and the intermediate value to provide a converted result in the other format. Each of these operations is performed as part of executing the single instruction within the decimal floating point unit, improving system performance, and reducing use of system resources.

In one example, as indicated, the conversion is from hexadecimal floating point to binary coded decimal. Binary coded decimal is a binary encoding of a decimal number, in which each decimal digit is represented by a fixed number of bits (e.g., 4 or 8 bits). Hexadecimal floating point is a format for encoding floating point numbers. In one example, a hexadecimal floating point number includes a sign bit, a characteristic (e.g., 7 bits) and a fraction (e.g., 6, 14 or 28 digits). The characteristic represents a signed exponent and is obtained by adding, e.g., 64 to the exponent value. The range of the characteristic is 0 to 127, which corresponds to an exponent range of, e.g., -64 to +63. The magnitude of a hexadecimal floating point number is the product of its fraction and the number 16 raised to the power of the exponent that is represented by its characteristic. The number is positive or negative depending on whether the sign bit is, e.g., zero or one, respectively.

A hexadecimal floating point number may be represented in a number of different formats, including a short format (e.g., 32-bit), a long format (e.g., 64-bit) and an extended format (e.g., 128-bit). In each format, the first bit (e.g., the first leftmost bit, bit 0) is the sign bit; the next selected number of bits (e.g., seven bits) are the characteristic, and in the short and long formats, the remaining bits are the fraction, which include, e.g., six or fourteen hexadecimal digits, respectively. In the extended format, the fraction is, e.g., a 28-digit fraction, and the extended hexadecimal floating point number consists of two long format numbers that are called the high-order and the low-order parts. The high-order part is any long hexadecimal floating point number. The fraction of the high-order part contains, e.g., the leftmost 14 hexadecimal digits of the 28-digit fraction, and the fraction of the low-order part contains, e.g., the rightmost 14 hexadecimal digits of the 28-digit fraction. The characteristic and sign of the high-order part are the characteristic and sign of the extended hexadecimal floating point number, and the sign and characteristic of the low-order part of an extended operand are ignored.

In one example, to convert a hexadecimal floating point number to binary coded decimal, the hexadecimal floating point number is converted to a decimal number, which is then represented in binary coded decimal. To convert a hexadecimal floating point number to decimal, a number of techniques may be used. One such technique includes multiplying a decimal equivalent of each digit of the hexadecimal number by 16 raised to a select power. For instance, for an integer part of the number (i.e., the part prior to the decimal point), the power starts at 0 for the rightmost hexadecimal digit and increases by one for each next digit, and for the fraction part (i.e., the part past the decimal point), the power starts at -1 for the leftmost hexadecimal digit and increases by one for each next digit.

As an example, a hexadecimal floating point number ABC.DEF is converted to decimal, as follows: ABC = 10 * 16² + 11 * 16¹ + 12 * 16⁰ = 2748; and DEF = 13 * 16⁻¹ + 14 * 16⁻² + 15 * 16⁻³ = 0.87084960. Thus, hexadecimal ABC.DEF = decimal 2748.87084960. Each decimal digit may then be represented in binary (e.g., 4 or 8 binary bits) to provide the binary coded decimal value.

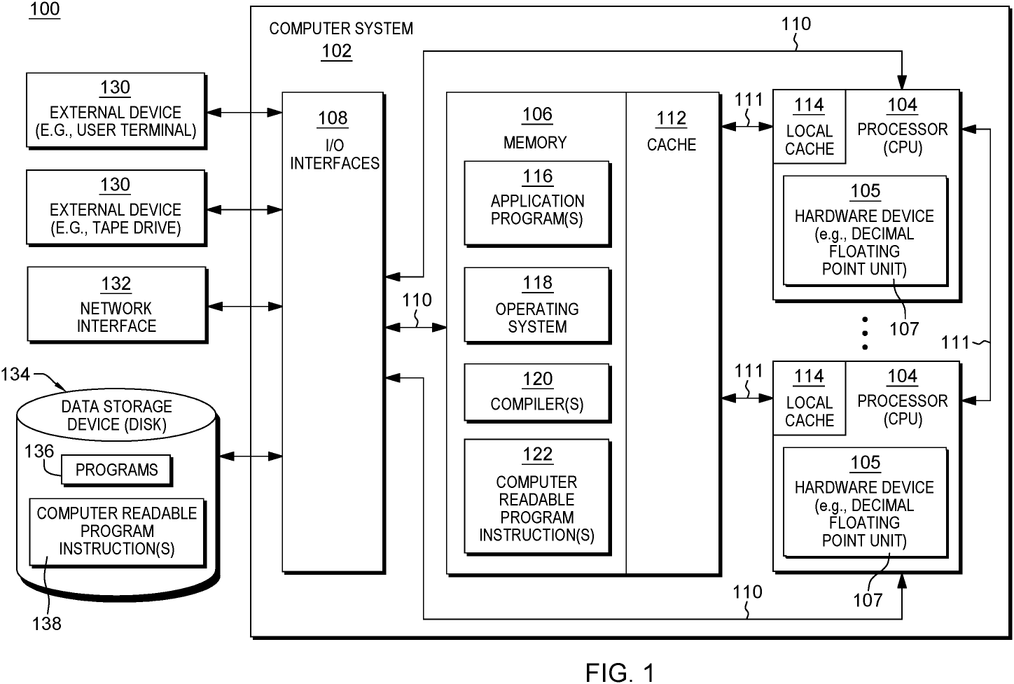

One embodiment of a computing environment to incorporate and use one or more aspects of the present invention is described with reference to FIG. 1. As an example, the computing environment is based on the IBM® z/Architecture® instruction set architecture, offered by International Business Machines Corporation, Armonk, New York. One embodiment of the z/Architecture instruction set architecture is described in a publication entitled, “z/Architecture Principles of Operation,” IBM Publication No. SA22-7832-12, Thirteenth Edition, September 2019, which is hereby incorporated herein by reference in its entirety. The z/Architecture instruction set architecture, however, is only one example architecture; other architectures and/or other types of computing environments of International Business Machines Corporation and/or of other entities may include and/or use one or more aspects of the present invention. IBM and z/Architecture are trademarks or registered trademarks of International Business Machines Corporation in at least one jurisdiction.

Referring to FIG. 1, in one example, a computing environment 100 includes, for instance, a computer system 102 shown, e.g., in the form of a general-purpose computing device. Computer system 102 may include, but is not limited to, one or more processors or processing units 104 (e.g., central processing units (CPUs) and/or special-purpose processors, etc.), a memory 106 (a.k.a., system memory, main memory, main storage, central storage or storage, as examples), and one or more input/output (I/O) interfaces 108, coupled to one another via one or more buses and/or other connections. For instance, processors 104 and memory 106 are coupled to I/O interfaces 108 via one or more buses 110, and processors 104 are coupled to one another via one or more buses 111.

Bus 111 is, for instance, a memory or cache coherence bus, and bus 110 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Processor 104 may include, in one or more examples, one or more hardware devices 105, such as one or more decimal floating point units 107, to perform certain tasks. In one or more aspects, the tasks include converting values from one data format (e.g., hexadecimal floating point) to another data format (e.g., binary coded decimal). The use of a decimal floating point unit to perform a conversion improves performance and reduces system resources to be used for the converting. In one aspect, decimal floating point unit 107 performs the conversion based on execution of a single instruction (e.g., a Vector Convert Hexadecimal Floating Point to Scaled Decimal instruction), in which various operations are performed including, for instance, converting one part of the input value from one format (e.g., hexadecimal floating point) to another format (e.g., binary coded decimal) to provide a converted value, performing one or more arithmetic operations on another part of the input value to provide an intermediate value and using the converted value and the intermediate value to provide a converted result in the other format. Each of these operations is performed as part of executing the single instruction in the decimal floating point unit (or other hardware device), improving system performance, and reducing use of system resources.

As examples, a decimal floating point unit 107 (or other hardware device 105) may be embedded within a processor, such as processor 104, and/or separate therefrom.

Memory 106 may include, for instance, a cache 112, such as a shared cache, which may be coupled to local caches 114 of one or more processors 104 via, e.g., one or more buses 111. Further, memory 106 may include one or more programs or applications 116, at least one operating system 118, one or more compilers 120 and one or more computer readable program instructions 122. Computer readable program instructions 122 may be configured to carry out functions of embodiments of aspects of the invention.

Computer system 102 may communicate via, e.g., I/O interfaces 108 with one or more external devices 130, such as a user terminal, a tape drive, a pointing device, a display, and one or more data storage devices 134, etc. A data storage device 134 may store one or more programs 136, one or more computer readable program instructions 138, and/or data, etc. The computer readable program instructions may be configured to carry out functions of embodiments of aspects of the invention.

Computer system 102 may also communicate via, e.g., I/O interfaces 108 with network interface 132, which enables computer system 102 to communicate with one or more networks, such as a local area network (LAN), a general wide area network (WAN), and/or a public network (e.g., the Internet), providing communication with other computing devices or systems.

Computer system 102 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 102. Examples, include, but are not limited to: microcode, device drivers, redundant processing units, external disk drive arrays, RAID systems, tape drives, and data archival storage systems, etc.

Computer system 102 may be operational with numerous other general-purpose or special purpose computing system environments or configurations. Examples of well-known computing systems, environments, and/or configurations that may be suitable for use with computer system 102 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In one example, a computing environment (e.g., processor 104 of computing environment 100) is used to convert an input value from one format (e.g., hexadecimal floating point) to another format (e.g., binary coded decimal). In such a conversion, in one example, multiple architected instructions are used, as depicted below (^ used herein refers to “raised to the power of”; e.g., 10 ^ 8 is equivalent to 10⁸):
1) Get integer part
   FIXR FP8,FP0 --> load FP integer
   LA R8,0×0
   CGDR R8,5,FP8:FP10 --> convert to binary
   VCVDG VRF24,R8,0×6,0 --> convert to packed decimal
   VSRP VRF24,VRF24,0×1e,0×18,0 --> shift for final result construction
2) Convert decimals
   LARL R8,L0016,offset=0×DC
   LD FP4,224(,R8) --> load 10^8
   LD FP6,232(,R8)
   SXR FP0,FP8 --> subtract integer part from original number
   MXR FP0,FP4 --> multiply by 10^8
2a) Convert the next 8 digits
   FIXR FP8,FP0
   LA R8,0×0
   CGDR R8,5,FP8:FP10
   VCVDG VRF25,R8,0×8,0
   VSRP VRF25,VRF25,0×18,0×10,0
2b) Subtract and then multiply by 10^8
   SXR FP0,FP8
   MXR FP0,FP4
2c) Convert the next 8 digits
   FIXR FP8,FP0
   LA R8,0×0
   CGDR R8,5,FP8:FP10
   VCVDG VRF26,R8,0×8,0
   VSRP VRF26,VRF26,0×10,0×8,0
   VAP VRF25,VRF25,VRF26,0×19,0
2d) Subtract and then multiply by 10^8
   SXR FP0,FP8
   MXR FP0,FP4
2e) Convert the next 8 digits
   LA R8,0×0
   CGDR R8,1,FP0
   VCVDG VRF26,R8,0×9,0
3) Construct the final result
   VAP VRF25,VRF25,VRF26,0×1a,0
   VAP VRF24,VRF24,VRF25,0×1e,0

In the above code, various instructions (e.g., machine instructions at the hardware/software interface), such as, for example, shift instructions (e.g., Vector Shift and Round Decimal-VSRP); convert instructions (e.g., Convert to Binary-CGDR, Vector Convert to Decimal-VCVDG); load instructions (e.g., Load Address Relative Long-LARL, Load Address-LA; Load-LD, Load floating point integer-FIXR); multiply instructions (e.g., Multiply (extended hexadecimal floating point)-MXR); add instructions (e.g., Vector Add Decimal-VAP); and subtract instructions (e.g., Subtract (and normalize extended hexadecimal floating point)-SXR), are used to convert an input value from one format (e.g., hexadecimal floating point) to another format (e.g., binary coded decimal). However, in accordance with one or more aspects of the present invention, instead of executing the above instructions to convert a hexadecimal floating point value to a binary coded decimal value, a single instruction at the hardware/software interface (e.g., a Vector Convert Hexadecimal Floating Point to Scaled Decimal instruction) is executed to perform the conversion. The single instruction, when executed, causes an execution flow to commence in a hardware device (e.g., hardware device 105), such as a decimal floating point unit (e.g., decimal floating point unit 107). By using a single instruction and one hardware device (e.g., hardware device 105, such as decimal floating point unit 107), performance is improved, and fewer system resources are utilized.

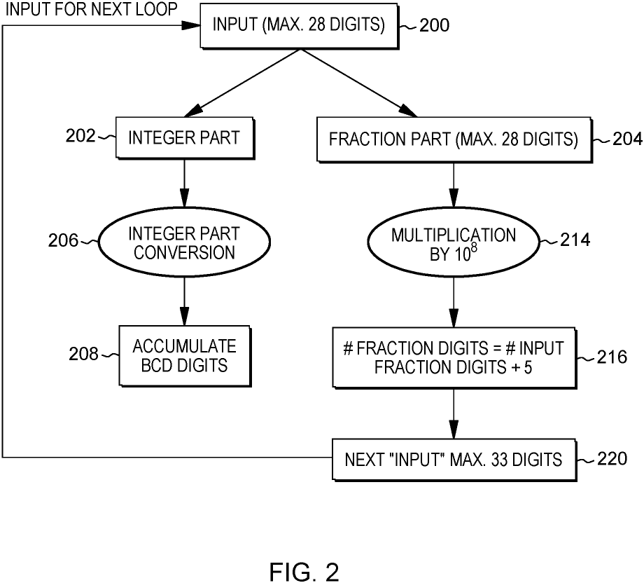

One example of processing associated with executing an instruction to perform a plurality of operations, as part of executing the instruction, to convert an input value from one format to another format is described with reference to FIG. 2. Initially, an input value in one format, such as hexadecimal floating point, is input to the processing 200. The input value is provided, e.g., by the instruction. As an example, the maximum number of digits for the input value is 28 digits. The input value is split into an integer part 202, if any, and a fraction part 204 of a maximum of, e.g., 28 digits. For instance, if the input value is ABC.DEF in hexadecimal floating point, integer part 202 is ABC and fraction part 204 is DEF.

Integer part 202 is converted 206 to binary coded decimal. To perform the conversion, in one example, two hexadecimal digits per cycle are converted to decimal digits, which are then represented as binary coded decimals, starting with the most significant digit, in which it takes four loops to convert eight hexadecimal digits. After each set of two hexadecimal digits is converted, the result (e.g., binary coded decimal values) is input to an accumulator to accumulate the binary coded decimal digits 208. As an example, hexadecimal ABC is converted to decimal 2748, which is then represented in binary coded decimal.

To convert the fraction part, in one example, fraction part 204 is multiplied 214 by a select value (e.g., a constant), such as 10⁸ = 5F5E100. Thus, DEF is multiplied by 10⁸ = 5F5E100 => 530CFA0F00. The number of decimal fraction digits in the product result is determined 216 to be the number of input fraction digits (e.g., 3) plus a select number (e.g., 5, which is based on the non-zero digits in the constant 5F5E100). The number resulting from the multiplication is input 220 for a next loop. The maximum number of digits is 33 for the next loop, in one example. In the next loop, for this example, 530CFA0 is the integer part that is converted to 87084960 in decimal. Therefore, ABC.DEF in hexadecimal is converted to a decimal number of 2748.87084960, which may be represented in binary coded decimal. The looping completes when, e.g., the desired number of fraction digits are obtained.

In one aspect, the above processing is performed within a hardware device (e.g., hardware device 105), such as a decimal floating point unit (e.g., decimal floating point unit 107). The hardware device is configured to directly convert an input value from one format (e.g., a hexadecimal floating point format) to another format (e.g., a decimal format, such as binary coded decimal), based on execution of and within a single instruction (e.g., a single architected hardware machine instruction at the hardware/software interface, e.g., a Vector Convert Hexadecimal Floating Point to Scaled Decimal instruction). For instance, the converting of one part of the input value to provide a converted value, the performing one or more arithmetic operations on another part of the input value to provide an intermediate value, and the using the converted value and the intermediate value to provide a converted result in the another format are performed within one instruction and within one unit, e.g., decimal floating point unit 107.

By configuring the decimal floating point unit to directly convert input data from one format (e.g., a hexadecimal floating point format) to another format (e.g., a decimal format, such as binary coded decimal) within execution of a single instruction, processing within the computer is improved by, for instance, reducing processing cycles used to perform the conversion and reducing system resources.

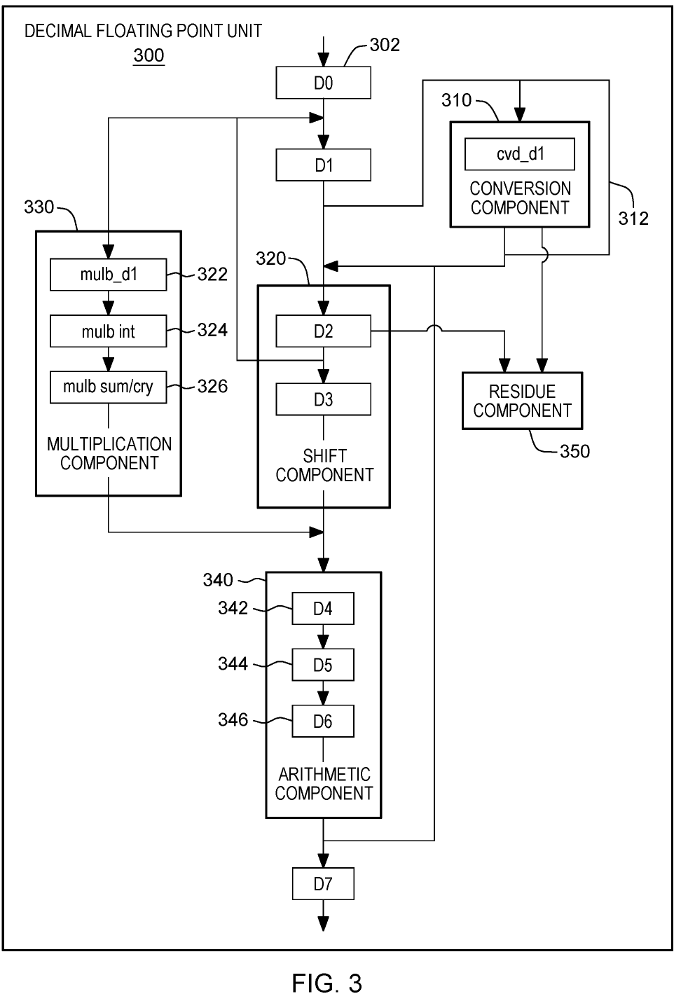

One example of a decimal floating point unit (e.g., decimal floating point unit 107) configured and used to directly convert input data from one format (e.g., a hexadecimal floating point) to another format (e.g., a decimal format, such as binary coded decimal) is described with reference to FIG. 3. In one example, a decimal floating point unit 300 is a hardware device that includes a plurality of hardware components, including, for instance, a conversion component 310, a shift component 320, a multiplication component 330 and an arithmetic component 340. Further, in one or more embodiments, decimal floating point unit 300 includes a residue component 350, described below. Each component is composed of one or more circuits used to perform various operations. Further, a decimal floating point unit may have additional, fewer and/or other components. Moreover, although a particular component is described herein as performing a particular operation, that operation (or aspects thereof) may be performed by additional and/or other components.

Decimal floating point unit 300 obtains (e.g., receives, is provided, pulls, etc.) data to be converted, based on execution of an instruction, such as a convert from hexadecimal floating point to binary coded decimal instruction (e.g., a Vector Convert Hexadecimal Floating Point to Scaled Decimal instruction, etc.) commencing on a processor, such as processor 104. Within execution of the instruction, the data, e.g., a hexadecimal floating point number, which is, for example, an input of the instruction, is obtained by decimal floating point unit 300 at a processing cycle D0 (302). Then, during processing cycle D1, as an example, conversion begins. For instance, an integer part of the hexadecimal floating point number is converted using conversion component 310. As described above, to convert the integer part, a looping process is performed, since two digits are converted at a time. Thus, conversion component 310 is within a loop 312 to convert two hexadecimal digits during each loop. An output of conversion component 310 is input to shift component 320, which passes the converted digits through the pipeline.

Output of shift component 320 is input to arithmetic component 340. Arithmetic component 340 accumulates the converted integer digits in decimal integer format, and further, provides a final output at D7.

Further, in one example, a multiplication component 330 is used to multiply 322 a fraction part of the input hexadecimal floating point number by a value (e.g., 10⁸ = 5F5E100) providing an integer value 324 represented as a hexadecimal sum and carry 326. An output of multiplication component 330 (e.g., integer value 324 represented as a hexadecimal sum and carry 326) is input to arithmetic component 340, in which during, e.g., cycles D4-D6 (342-346), the sum and carry are added together to provide an intermediate hexadecimal fraction.

The intermediate hexadecimal fraction is provided to shift component 320 for a next loop. In one example, the shift component latches the intermediate hexadecimal fraction at D2. The integer part is passed from D2 to conversion component 310 via, e.g., latch D1, and the fraction part is passed from D2 to multiplication component 320.

Thus, in the example provided above with ABC.DEF, ABC in hexadecimal is converted using conversion component 310 to provide 2748 in decimal. In one example, the conversion includes a cascade of doubler circuits. One bit after another is fed into the doubler circuit starting with the most significant bit. Each bit is doubled as often as it has to according to its weight (e.g., 2^n) in the input. Eight bits are converted in one cycle and the result of the conversion also participates in subsequent stages of doubling. This is performed for four cycles/loops in which seven hexadecimal digits are converted to eight decimal digits. The resulting eight decimal digits are passed to the shift component and are accumulated with decimal digits from prior loops. This can be performed by shifting the prior decimal digits by eight digits to the left before accumulation (shift by 8 decimal digits corresponds to a multiplication of 10^8).

Further, in one example, the fraction part DEF is multiplied by 10⁸ using multiplication component 330 and the resulting value, 530CFA0F00, provided by, e.g., arithmetic component 340 is passed to shift component 320 to split the integer and fraction part for another loop.

As described herein, in one or more aspects, different paths of the conversion process operate in different data formats, and each format is supported by the decimal floating point unit. For instance, the multiplication is in hexadecimal floating point, the conversion is from a hexadecimal integer format to a decimal integer format, and the accumulation of the converted decimal integer digits is in decimal integer format. In one aspect, each of the conversion logic and the multiplication logic is located in separate components (e.g., conversion component 310 and multiplication component 330) and the decimal accumulation is executed in the regular pipeline (e.g., in arithmetic unit 340). This allows the parallel (or substantially in parallel--e.g., at least a portion of the processing is performed at the same time) execution of the convert operation, the multiplication and decimal accumulation within one unit.

In accordance with an aspect of the present invention, a hardware device, such as a decimal floating point unit (e.g., decimal floating point unit 107, 300), is configured and used to execute a plurality of operations within an instruction to convert an input value from one format (e.g., a hexadecimal floating point format) to another format (e.g., a binary coded decimal). The decimal floating point unit executes in parallel (or substantially in parallel) hexadecimal multiplication, hexadecimal integer to decimal integer conversion and accumulation of decimal integer digits within one instruction and within the one decimal floating point unit. This improves performance within a processor by, for instance, improving program code performance, such as COBOL performance, and/or reducing the number of processing cycles used in the conversion, which saves time and resources, thereby improving execution of a processor, computer system and/or computing environment in which the hardware device is used and/or associated with.

In one aspect, a fraction value of an input hexadecimal floating point number may be split if, for instance, the data path becomes too narrow. For instance, the multiplier dataflow may cover up to, e.g., 28 hexadecimal digits. The fraction part is multiplied in each loop by a select value of, e.g., 10⁸ = 5F5E100 in hex. The fraction width may grow by a specified number of digits (e.g., 5 digits) in each loop, since the constant has, e.g., five continuous non-zero digits. Therefore, a next input to the multiplication may exceed the dataflow width if there is no integer part contained in the fraction after the multiplication. This is the case when, for instance, the input exponent is smaller than zero. The intermediate fraction of the instruction may grow up to 28 + 6 + 3 * 5 = 49 hexadecimal digits. The multiplication is to cover, e.g., all digits to avoid errors in the calculation.

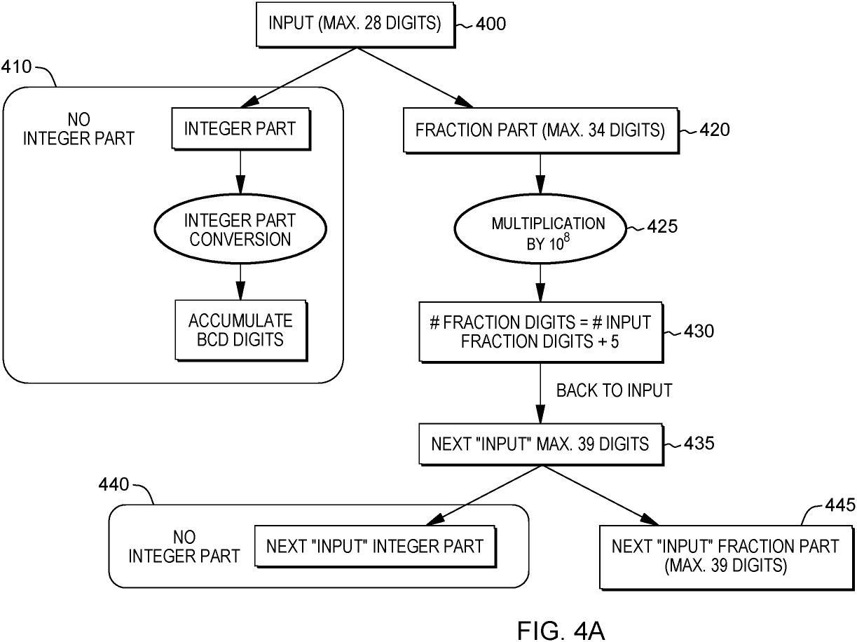

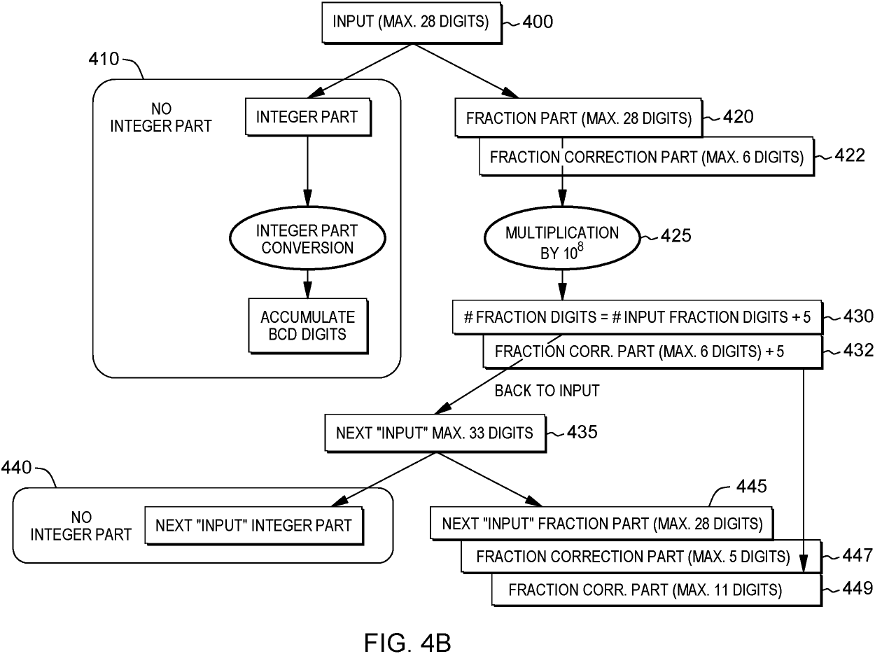

In one aspect, even a fraction that is fed into the first iteration may grow too wide. For instance, an integer point is to be aligned to a multiple of, e.g., seven to fit the adjustment by, e.g., seven hexadecimal digits in each loop (10⁸ = 5F5E100 hex). This may lead to a fraction of up to, e.g., 34 hexadecimal digits for the first iteration. A multiplier tree is expensive in terms of area; therefore, increasing it to fit the width is not preferred. Further, performing a classical split and accumulate increases the cycle count of one iteration loop, and therefore, negatively affects performance. Thus, in accordance with one or more aspects, the fraction is split, as described herein with reference to FIGS. 4A-4B.

As shown in FIG. 4A, in one example, an input hexadecimal value 400 has a maximum of28 digits. In this one example, the input value has no integer part 410 and therefore, there is only a fraction part 420 of the input value. The fraction part may have up to a maximum of 34 digits to align the integer point. The fraction is multiplied 425 by a select value of, e.g., 10⁸ = 5F5E100 hex. The number of fraction digits is equal to the number of input fraction digits plus a select number (e.g., 5) 430. The fraction digits, which may now be a maximum of 39 digits 434, is the next input. Again, there is no integer part 440 and the next input fraction part 445 is a maximum of 39 digits. If the next input fraction part is greater than, e.g., 28 digits, the hardware data path is considered too small, in one example, and the next multiplication may produce an inexact result. Thus, in accordance with an aspect of the present invention, the fraction part is split, as described with reference to FIG. 4B.

Referring to FIG. 4B, a fraction part of the input value, if greater than, e.g., 28, is split into a fraction part 420 with a maximum of 28 digits and a fraction correction part 422 with a maximum of 6 digits. Each part, fraction part 420 and fraction correction part 422, is multiplied 425 by a select value of, e.g., 10⁸ = 5F5E100 hex. The number of fraction digits is equal to the number of input fraction digits plus a select number (e.g., 5) 430. The fraction correction part is a maximum of 6 digits plus a select number (e.g., 5) 432. The next input 435 is a maximum of 33 digits, so assuming no integer part 440, the next input fraction part, if greater than 28 digits, is split into a next input fraction part 445 with a maximum of 28 digits and a first fraction correction part 447 with a maximum of 5 digits and further has a second fraction correction part 449 associated therewith with a maximum of 11 digits (this is fraction correction part 432 multiplied again by the select value).

One example of the split processing is described below:

Assume an input fraction value of E69594BEC44DE15B4C2EBE68798B with an exponent of -12. The input fraction is shifted to align with a 7 digit shift performed later, providing an input fraction of 00000E69594BEC44DE15B4C2EBE68798B. Since this value is 33 digits, which is greater than, e.g., 28 digits, a split of the input fraction occurs providing a fraction part of 00000E69594BEC44DE15B4C2EBE6 and a fraction correction part of 8798B. The fraction part is multiplied by a select value (e.g., 5F5E100 hex (10⁸ decimal)) providing 0000055E63B88C230E77E7EE106927326, which is a next input value. Similarly, the fraction correction part is multiplied by the select value providing 32837BDA2B.

The next input value (0000055E63B88C230E77E7EE106927326) is still greater than 28 digits, so the splitting and multiplying are performed again, yielding: 0000055E63B88C230E77E7EE1069 * 5F5E100 = 000001FFFFFFFFFFFFFFFFFFFFFFDE949 (another next input value from the second split); and 27326 * 5F5E100 = E9A189266 (another correction value from the second split). Further, 32837BDA2B (correction value from the first split) * 5F5E100 = 12D15A65A7CE6CB.

Based on, for instance, the exponent, the amount shifted and/or the select value, it is determined that the other next input value (000001FFFFFFFFFFFFFFFFFFFFFFDE949) now has two integer digits 1F and fractional digits of FFFFFFFFFFFFFFFFFFFFFDE949. For instance, since the initial exponent is -12, each multiplication loop increases the exponent by 7. Thus, the exponent after two multiplication loops is -12 + 14 = 2, which means that the number has two integer digits. The decimal equivalent of 1F is 31; however, the correction part is to be considered. Therefore, the correction terms are accumulated (e.g., E9A18926600000 (the zeros are added to match the weight) + 12D15A65A7CE6CB = 216B72F80DCE6CB) and used in determining the converted result. For instance, the fraction value of the other next input value, FFFFFFFFFFFFFFFFFFFFFDE9490000000000 with trailing zeros added + 216B72F80DCE6CB = 1000000000000000000000000002F80DCE6CB. There is a 1 in the integer part and thus, that is added to 31 for a converted result of 32.

As described herein, in accordance with one or more aspects, a fraction, HRX, is split before each iteration into, e.g., a 28 hex digits part, HR, and a correction part, EX. Thus, HRX = HR + EXG (EXG is the correction part(s) in total). An equation for the first iteration is, e.g., HR * 10⁸ = (HR0 + E0) * 10⁸ = HR0 * 10⁸ + E0 * 10⁸ = HR1 + E1 + E0 * 10⁸ = HR1 + E1G. An equation for the second iteration is, e.g., HR * (10⁸)² = (HR1 + E1G) * 10⁸ = HR1 * 10⁸ + E1G * 10⁸ = HR2 + E2 + E1G * 10⁸ = HR2 + E2G. The correction term after the i-th iteration is, e.g., EiG = Ei + E(i-1)G * 10⁸. A last iteration is equal to, e.g., HRN = HN + ENG = HN + EN + E(N-1)G * 10⁸. The result is incremented if HN + ENG leads to a carry out into the integer part. In one aspect, the correction calculation uses free multiplier cycles, and thus, there is no impact to the number of cycles to be used for one iteration loop.

In one aspect, the input of a multiplication, having a form result = A * constant, where A is the fraction and the constant is 10⁸, is split in multiple (e.g., two) parts to fit the data path width of a binary multiplier tree in a decimal floating point unit. The decimal floating point unit pipeline and binary multiplier stages that are used in the converting of an input value are used to calculate correction term(s) such that the correction terms are accumulated over the iteration loops for the final product so that no additional latency is added.

In one aspect, a multiplier feedback path is used to perform the accumulation of the correction terms that are used. The calculation of the correction terms is recursive: EiG = Ei + E(i-1)G * 10⁸ = Ei + (E(i-1) + E(i-2)G * 10⁸)= Ei + E(i-1) * 10⁸+ E(i-2)G * 10⁸. If, for instance, a decimal floating point adder was used to accumulate the correction terms, the decimal floating point unit pipeline would be occupied for two more slots: one for the addition of the multiplier sum and carry terms and one for the addition of the two products of the equation. A certain offset of the two calculations would be used due to pipeline feedback path restrictions. A larger number of cycles per loop would be used to fit the calculations into one loop resulting in a performance degradation.

Thus, in accordance with one aspect, an existing multiplier feedback path is used to perform the accumulation of the correction terms: Calculate E(i-1)G * 10⁸ of the equation = EiG = Ei + E(i-1)G * 10⁸ by using the feedback part of the multiplier: E(i-1)G * 10⁸ = E(i-1) * 10⁸ + E(i-2)G * 10⁸. This allows back to back calculation of the correction term(s) with, e.g., just one additional cycle. The feedback result from the previous correction term calculation arrives at the multiplier input at the correct cycle. No additional staging is used. The control logic gets easier and the decimal floating point unit pipeline becomes more flexible for the other calculations used. A correction term calculation fits within one loop.

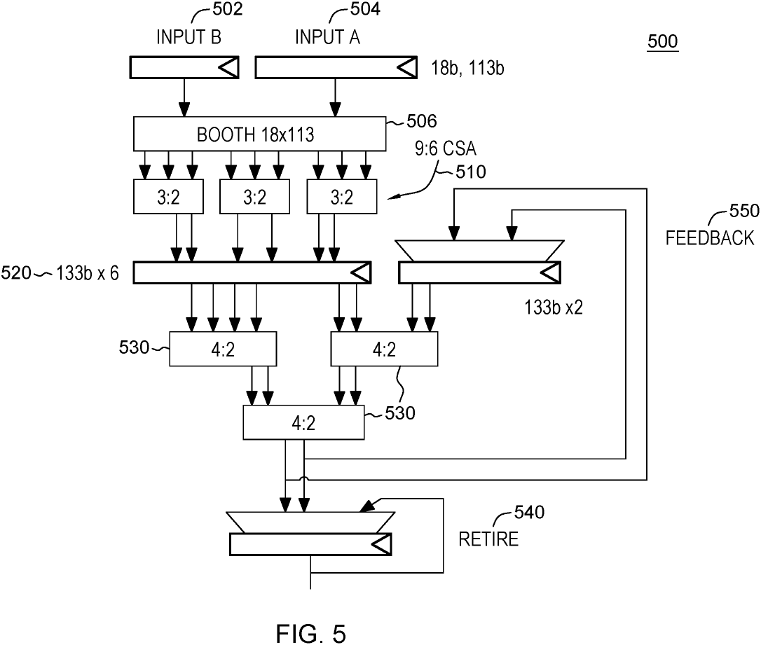

One example of a multiplier with a feedback path is described with reference to FIG. 5. The multiplier is, for instance, at least part of a multiplication component (e.g., multiplication component 330).

Referring to FIG. 5, in one example, a multiplier 500 includes one input, input B 502, and another input, input A 504. As an example input B 502 is a select value, e.g., 10⁸, and input A 504 is the fraction. Both inputs are input to a Booth encoding 506, and a Booth encoding of input B 502 is performed. For instance, 10⁸ = x “5F5E100” is used for Booth encoding in both multiplication cycles. As examples, E(i-1) is the multiplicand of the first cycle and E(i-2) G x 10⁸ is the multiplicand of the second cycle. In one example, an alignment of E(i-1) and E(i-2) G in input register A is to be adjusted to compensate for a shift in a feedback path 550.

In one example, one multiplicand is latched and the value is held during the cycles (e.g., all cycles) of the multiplication. The other multiplicand is used for Booth encoding (17 bits/cycle) and is shifted in each cycle to cover the bits/digits at the end of the multiplication. Feedback path 550 is used for accumulation.

An output of Booth encoding 506 is input to a reduction tree 510. The reduction tree is split over two cycles, since multiplier 500 is, e.g., two cycles long. The first cycle includes Booth encoding and some reduction. There are, e.g., six latches 520 to contain the sum and carry terms of the reduction up to this point. Then, there are additional reductions with a plurality of 4:2 encoders 530 until just a sum and carry are left. The sum and carry are latched at the end to go back into the pipe. In one example, feedback path 550 is used to feed back bits that are to be used; the least significant bits are retired 540, in one example.

As described herein, in one aspect, a multiplication tree with a feedback path is used to perform a multiplication of two numbers with a constant and an accumulation of the products to provide a result: result = A * constant + B *constant, where the constant feeds the Booth encoding and the multiplicand switches in the second cycle from A to B with an appropriate offset. The constant, input B, is used for several multiplications. By choosing a correct alignment of the input, the feedback path is used to accumulate two multiplications, thereby saving one path through the arithmetic component. For instance, a first correction term passed to the multiplier is aligned to a certain bit position N, which is preselected. A second correction term, which is passed to the multiplier is then aligned to bit position N + X, where X is the number of retired bits of the multiplication component. The feedback path includes a right shift by X bits if the multiplication component retires X bits/cycle. The first correction term is aligned far enough to the left to only retire zero bits. The complete product is then shifted right by X bits on the feedback path. The alignment with respect to the second correction term is then zero, since both terms are at this point aligned to bit position N + X.

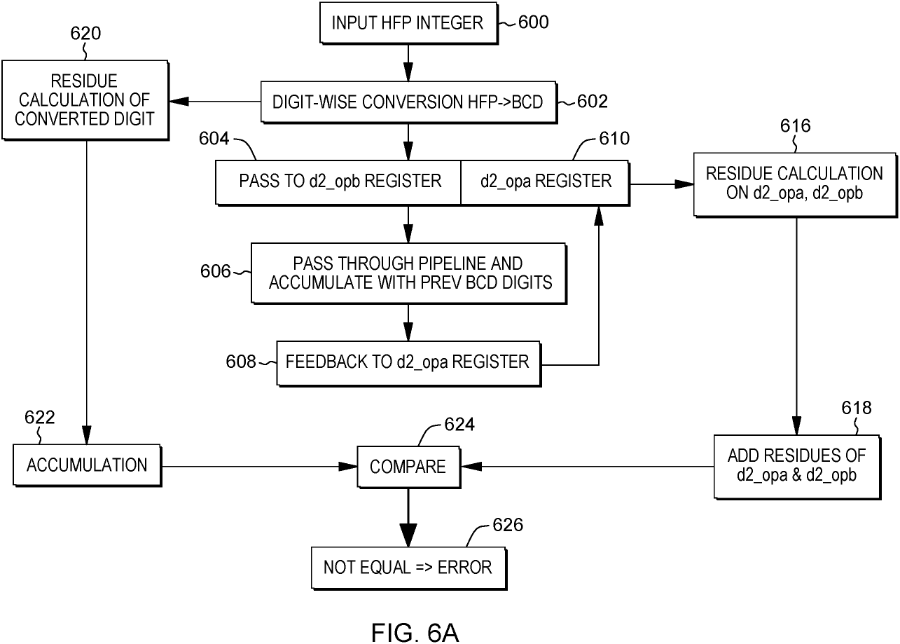

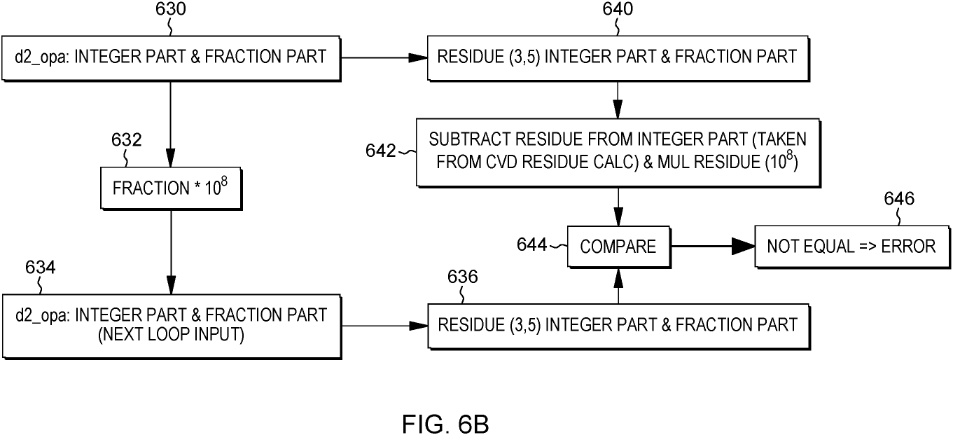

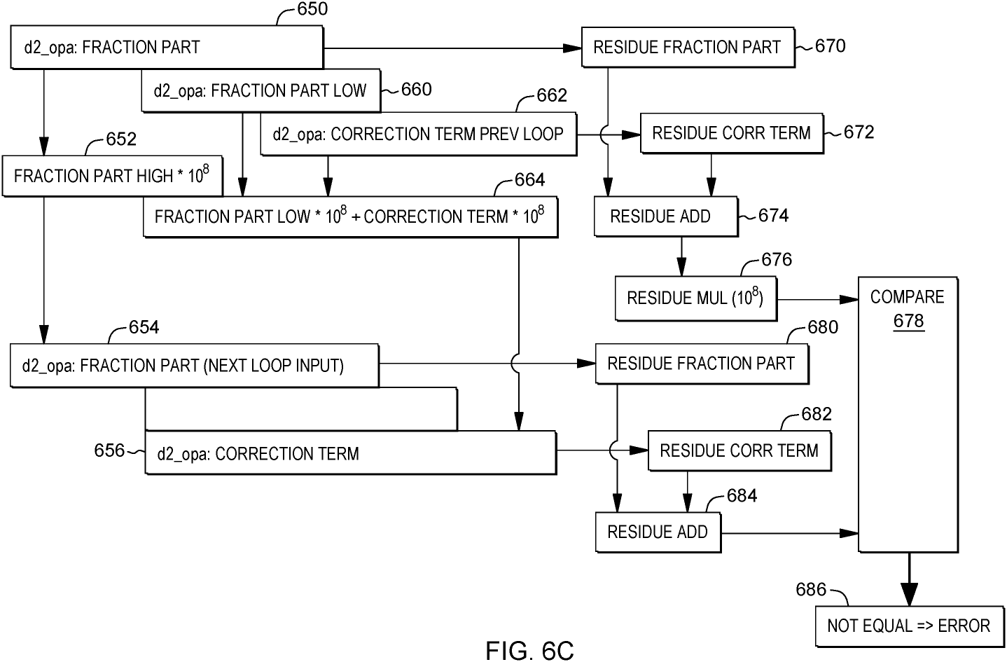

In one or more aspects, reliability, availability and serviceability (RAS) checking is performed for various operations of converting the input value from one format to another format, including, for instance, the conversion of the integer part, multiplications of the fraction part and accumulations. To achieve high availability, reliability, and serviceability, the circuits to perform one or more of these operations is checked for errors in the calculations due to bit flips and/or broken circuits, etc. For instance, conversion and accumulation checking are accomplished by performing residue 3 checking. Similarly, multiplication checking is accomplished by performing residue 3 and 5 checking. Examples of the checking are described with reference to FIGS. 6A-6C.

Referring initially to FIG. 6A, one example of conversion and accumulation residue 3 checking is described. In one example, the residue is accumulated over the converted digits (e.g., all converted digits) and compared after each loop. This takes into consideration the storing of previous calculated digits and the accumulation of the previous converted digits.

In one example, a hexadecimal floating point integer is input to the logic 600. A digit-wise conversion from hexadecimal floating point to binary coded decimal is performed 602. A result of each conversion is passed to a register, referred to as a d2_opb (operand b) register, 604. The result passes through the pipeline and accumulates with previous binary coded decimal digits 606. This is fed back 608 to another register, referred to as a d2_opa (operand a) register, 610.

Further, in accordance with one aspect, a residue calculation is performed on the values stored in registers d2_opa, d2_opb 616. For instance, residue 3 checking is performed so each digit is divided by 3 and the remainder is taken. The residues of the values in registers d2_opa, d2_opb are added together 618 (e.g., the remainders are added) to provide a sum. Moreover, in one aspect, a residue calculation is performed for each converted digit 620. Each remainder from the residue calculation is accumulated 622. The accumulated value from accumulation 622 is compared 624 to the sum provided by add residues 618. If they are unequal, an error has occurred 626.

As described, in one or more aspects, recursive calculations to convert a scaled hexadecimal floating point number to a decimal integer are checked by generating a digit-wise residue of the converted digits and accumulating them, generating a residue value of the converted decimal digits including, e.g., all previous calculated digits, and comparing the accumulated digit-wise residues and the residue value after each iteration to determine if the calculation is correct. If the calculation is incorrect, an error is signaled.

In one example, the residue calculation is performed by a residue component (e.g., residue component 350 of FIG. 3). As shown in FIG. 3, in one example, residue component 350 may receive input from a plurality of sources, including, e.g., D2 of shift component 320 and conversion component 310. In other examples, one or more other components of the hardware device (e.g., decimal floating point unit) are used to perform the residue checking.

As indicated above, another checking that may be performed is multiplication residue checking. Multiplication residue checking may be performed when there is an integer part and/or when there is no integer part. In one example, multiplication residue checking includes checking a multiplication result for each loop. A result is written back to a register, such as d2_opa, from which the residue is calculated. In one example, the residue 3 and 5 values of the digits converted in the loop are to be subtracted from the input value in the d2_opa register, in case of available integer digits. One example of multiplication residue checking when there is a loop with an integer part is described with reference to FIG. 6B.

Referring to FIG. 6B, an integer part and a fraction part of a hexadecimal floating point number are located in a register, e.g., register d2_opa 630. The fraction part is multiplied by a select value, such as 10⁸ hex, 632. The integer part and the fraction part resulting from the multiplication are stored in register d2_opa, which is a next loop input 634. Additionally, in accordance with one aspect, residue 3 and residue 5 calculations are performed, respectively, on the value stored in register d2_opa, which is the integer part and the fraction part resulting from the multiplication, to provide a first residue value 636. Further, residue 3 and residue 5 calculations 640 are performed, respectively, on the input value in register d2_opa, which is the integer part and fraction part prior to the multiplication, to obtain an overall residue. A calculated residue of the integer part (taken from the conversion residue calculation in, e.g., FIG. 6A) is subtracted from the overall residue provided in 640, and the result is multiplied by a select value, such as the residue of 10⁸ hex, 642 to provide a second residue value. The second residue value determined in 642 is compared 644 with the first residue value calculated in 636. If they are unequal, then an error has occurred 646.

As described, in one or more aspects, multiplication for a hexadecimal floating point fraction is checked using residue 3 and residue 5, where the fraction is part of a hexadecimal floating point number including a fractional part and an integer part. For instance, an overall residue of the integer and fractional part is generated, and a calculated residue of the integer part is subtracted therefrom. This result is multiplied with the residue of the multiplicand and that result is compared against the generated residue of the product after each iteration loop to determine if the calculation is correct and, if not, signaling an error.

Another checking that may be performed is multiplication residue checking in which there is a loop without an integer part. In one example, a subsequent calculation of the correction terms is to be taken into account in the case of no available integer digits. The data to be checked is spread over cycles. Checking of each loop is still possible. One example of multiplication residue checking when there is a loop without an integer part is described with reference to FIG. 6C.

Referring to FIG. 6C, in one example, a fraction part is located in a register, e.g., d2_opa 650. A high part of the fraction is multiplied by a select value, such as 10⁸ hex, 652. A result of the multiplication is stored in, e.g., register d2_opa, which is a next loop input 654. Further, in one example, a low part of the fraction 660 stored in, e.g., d2_opa is multiplied 664 by a select value, such as 10⁸ hex, and a result of that multiplication is added to a correction term of a previous loop stored in d2_opa 662 multiplied by the select value (e.g., 10⁸ hex) resulting in a correction term stored in, e.g., d2_opa 656.

In accordance with one aspect, a residue of the fraction part 670 and a residue of the correction term of the previous loop 672 is added 674 and the result is multiplied by a select value, such as residue value 10⁸, 676 providing a result, which is compared 678 to a result from performing a residue add 684 of a residue fraction part 680 (of the next loop input) and a residue correction term 682. If the compare is unequal, an error has occurred 686.

As described, in one or more aspects, a multiplication for a hexadecimal floating point number is checked using residue 3 and residue 5, where there is a fractional part and a fraction correction part. For instance, an overall residue of the fractional part is calculated and added to a calculated residue of the fraction correction part and multiplying this with the residue of the multiplicand, which is compared against the sum of the residues of the product of the high fraction part and the product of the addition of the low fraction part and the previous correction fraction with the multiplicand after each iteration loop to determine if the calculation is correct and, if not, signaling an error.

In one or more aspects, various data paths available in a decimal floating point unit (or other hardware device) are used to convert hexadecimal integer digits to decimal integer digits, multiply hexadecimal fractional digits with a constant, and accumulate decimal integer digits in parallel (or substantially in parallel). A conversion data path used for binary integer to decimal integer may be utilized, without overhead for the conversion of hexadecimal floating point integers to decimal integers. The conversion and the multiplication use separate hardware elements within the decimal floating point unit to perform the calculations. The accumulation utilizes the main decimal floating point pipeline. The parallel execution can therefore be realized by carefully coordinating the various executions within the decimal floating point unit.

In one or more aspects, a width of a fraction of an input value may exceed the data path width, if, for instance, the input exponent is smaller than zero. Extending the data path to cover all possible fraction lengths is expensive in terms of area and power. To overcome this issue, in one example, the fraction that is used for the multiplication in a “next fraction input” part is split to have a fraction part having a width of, e.g., at most 28 hexadecimal digits and a fraction correction term. The two different parts are multiplied separately with the constant (e.g., 10⁸) generating a “next input” to the next loop and a next loop correction term. The final correction term is to be added to the final fraction. The converted decimal digits are increased by one if this addition produces a carry into the integer position. Free multiplier cycles can be used for this calculation, so no additional latency is added.

In one example, a correction fraction calculation is to include the correction fraction calculations of all utilized loops. The calculation is recursive: EiG = Ei + E(i-1)G*10^8 = Ei + (E(i-1) + E(i-2)G*10^8)*10^8 = Ei + E(i-1)*10^8 + E(i-2)G*10^{2*8}. A state of the art implementation may use the decimal floating point unit adder to do the accumulation. The decimal floating point unit pipeline would be occupied by two more cycles: one for the sum and carry addition of the product of the previous loop correction term with the constant and one for the accumulation of the correction terms, and the loop length would be limited by this calculation. Instead, in accordance with one or more aspects, a multiplier feedback path is used for the accumulation. The two input terms are already available back to back at the multiplier input. The first term is shifted left to adjust for the right shift of the existing multiplier feedback path and the accumulated fraction correction term is available in sum and carry format with just one cycle offset. This allows the correction calculation to be performed within an optimal loop length by adding, for instance, an additional multiplexor port to the input of the multiplier logic.

Yet further, in one or more aspects, the circuits are checked for errors in the calculation due to, e.g., bit flips or broken circuits to achieve high availability, high reliability and high serviceability. The instruction includes, e.g., three parts: conversion, accumulation, multiplication, and the three parts are to satisfy the error correction standards. In one example, accuracy checking is performed for the three parallel executed calculations for each loop.

In one example, conversion and accumulation residue 3 checking includes accumulating the residue of the digits that are passed to the conversion logic, comparing this residue against the generated residue of the digits in two registers, where one contains the accumulated digits from previous loops and the other one contains the latest loop’s converted digits. This covers the storing of previous calculated digits and the accumulation of the previous converted digits with the converted digits of the latest loop. This check is performed in each loop, in one example.

In one example, the multiplication residue 3 and 5 checking includes the following: the input of the multiplication is in the d2_opa register. This register also includes the integer part of the fraction when the input exponent is larger than zero. The residue is generated from the d2_opa register. The result of the multiplication is written back into the d2_opa register, a number of cycles later (e.g., 7 cycles) and the residue is again generated from this value.

As examples, there are two different scenarios for the checking of the multiplication:

a) The fraction in d2_opa contains integer digits.

The residue 3 and 5 values of the integer digits converted to decimal in the loop are to be subtracted from the residue of the input value in d2_opa, in case of available integer digits. The resulting residue is then multiplied by the residue of the constant and held until the residue of the product is generated. The two values are compared, and an error is reported if the values do not match.

b) The fraction in d2_opa contains no integer digits.

The subsequent calculation of the correction terms is to be taken into account in the case of no available integer digits since not all of the fraction digits in d2_opa participate in one multiplication. The input of the multiplication is the generated residue of the fraction of the previous loop and the generated residue of the previous correction term. These values are added together and then they are multiplied by the residue of the constant. The value is stored for a number of cycles (e.g., 7 cycles) and is then compared with the generated residue of the next input fraction added to the generated residue of the next loop’s correction term. An error is reported if they do not match. This checking is performed for each loop, in one example.

One or more aspects of the present invention are inextricably tied to computer technology and facilitate processing within a computer, improving performance thereof. The use of a hardware device, such as a decimal floating point unit, to perform conversions from one data format to another data format within execution of a single instruction improves processing within a processor, computer system and/or computing environment; reduces program code and the number of instructions (at the hardware/software interface) that are used; increases processing speed by reducing the number of processing cycles; and reduces use of system resources. Thus, the functioning of a processor, computer system and/or computing environment in which the decimal floating point unit is included and/or associated with is improved.

Moreover, by improving conversion processing and processing associated with transactions and/or other processing that uses the converted results, improvements in technologies that use those transactions and/or other processing is also realized. These technologies include, but are not limited to, engineering, manufacturing, medical technologies, automotive technologies, computer processing, etc.

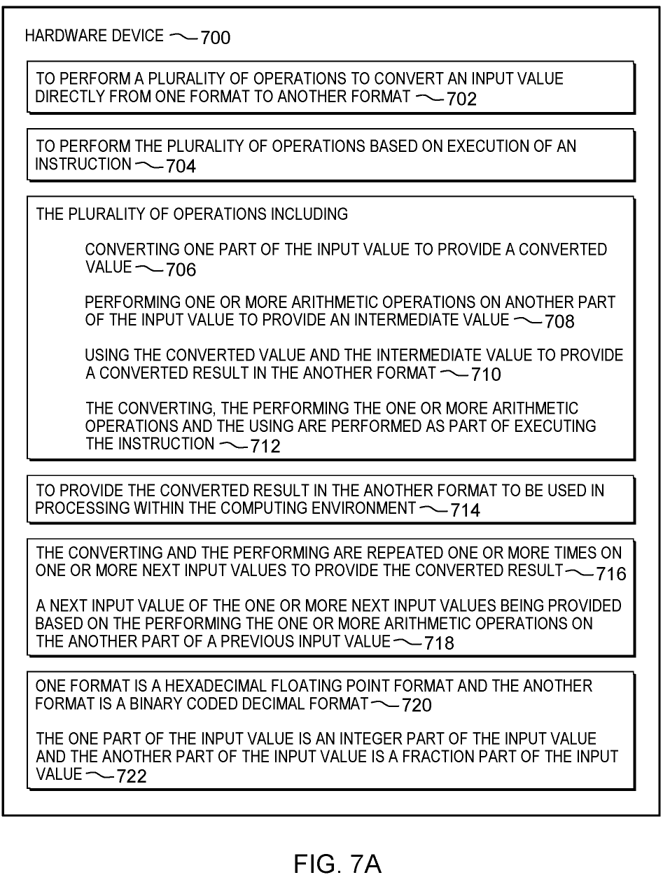

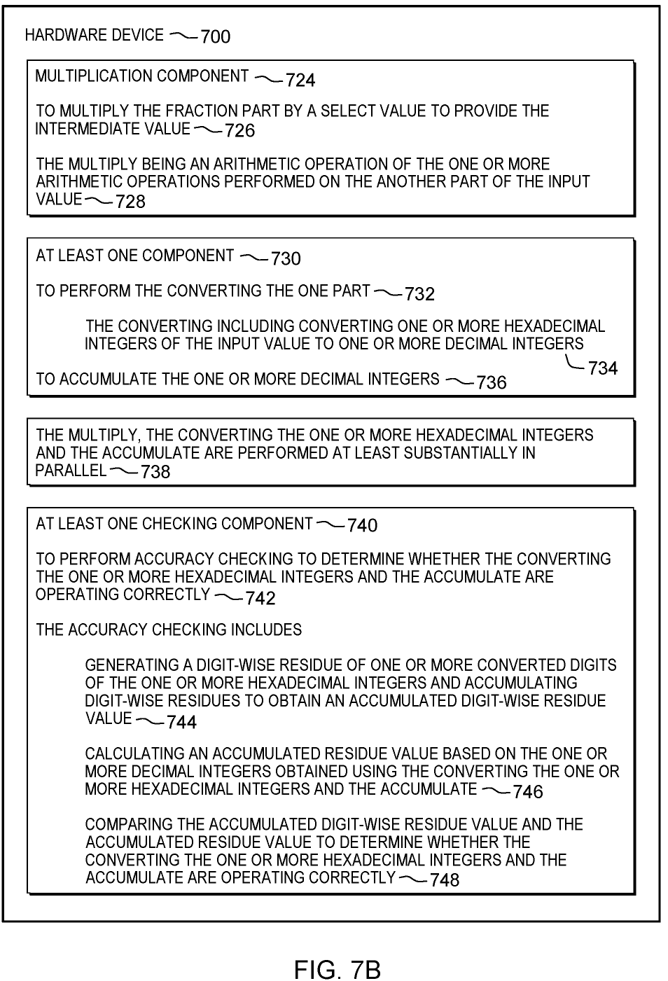

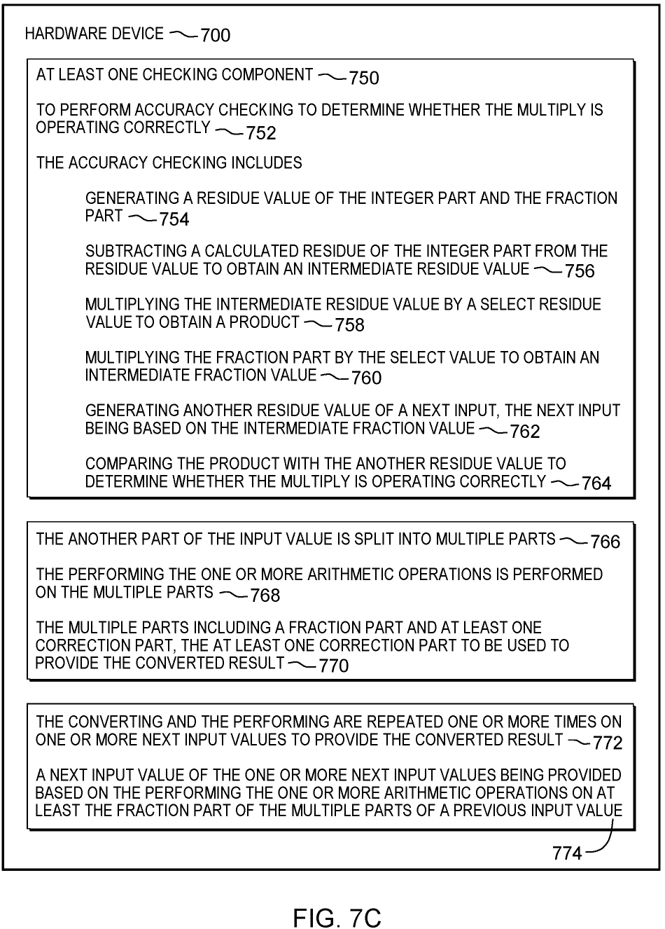

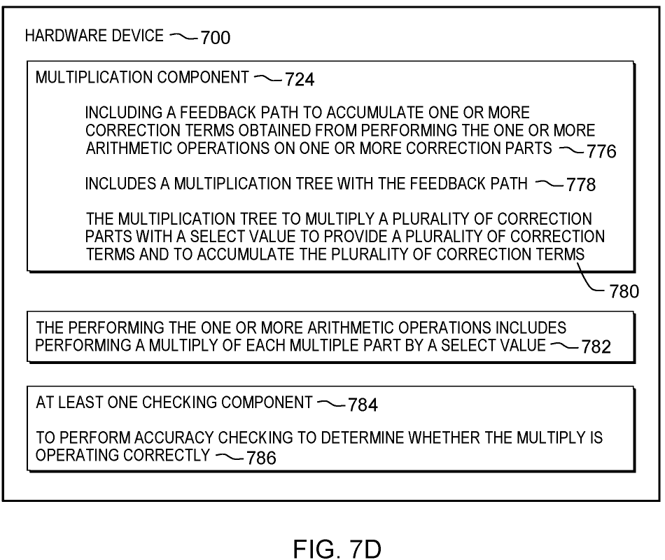

Further details of one embodiment of facilitating processing within a computing environment, as it relates to one or more aspects of the present invention, are described with reference to FIGS. 7A-7D.

Referring to FIG. 7A, in one aspect, a hardware device 700 (e.g., a decimal floating point unit, such as decimal floating point unit 107) is to perform a plurality of operations to convert an input value directly from one format to another format 702. The hardware device is to perform the plurality of operations based on execution of an instruction 704. The plurality of operations includes, for instance, converting one part of the input value to provide a converted value 706, performing one or more arithmetic operations on another part of the input value to provide an intermediate value 708, and using the converted value and the intermediate value to provide a converted result in the other format 710. The converting, the performing the one or more arithmetic operations and the using are performed as part of executing the instruction, in one example 712. The hardware device is to provide the converted result in the other format to be used in processing within the computing environment 714.

By using the hardware device to perform the plurality of operations as part of executing an instruction, performance is improved, and use of system resources is reduced. Further, the speed at which conversions are performed is increased without losing precision compared to a software solution.

In one aspect, the converting and the performing are repeated one or more times on one or more next input values to provide the converted result 716. A next input value of the one or more next input values is provided based on the performing the one or more arithmetic operations on the other part of a previous input value 718.

As examples, the one format is a hexadecimal floating point format, and the other format is a binary coded decimal format 720. Further, in one or more examples, the one part of the input value is an integer part of the input value, and the other part of the input value is a fraction part of the input value 722.

In one aspect, referring to FIG. 7B, hardware device 700 includes a multiplication component 724 (e.g., multiplication component 330) to multiply the fraction part by a select value to provide the intermediate value 726. The multiply is an arithmetic operation of the one or more arithmetic operations performed on the other part of the input value 728.

Further, in one aspect, hardware device 700 includes at least one component 730 (e.g., conversion component 310, arithmetic component 340, and/or additional, fewer and/or other components) to perform the converting the one part 732 and to accumulate one or more decimal integers 736. The converting includes converting one or more hexadecimal integers of the input value to one or more decimal integers 734. In one example, the multiply, the converting the one or more hexadecimal integers and the accumulate are performed at least substantially in parallel 738.

By performing the multiply, the converting the one or more hexadecimal integers and the accumulate at least substantially in parallel, the use of processing cycles is reduced and processing speed is increased.

Yet further, in one aspect, hardware device 700 further includes at least one checking component 740 (e.g., residue component 350) to perform accuracy checking to determine whether the converting the one or more hexadecimal integers and the accumulate are operating correctly 742. The accuracy checking includes, for instance, generating a digit-wise residue of one or more converted digits of the one or more hexadecimal integers and accumulating digit-wise residues to obtain an accumulated digit-wise residue value 744, calculating an accumulated residue value based on the one or more decimal integers obtained using the converting the one or more hexadecimal integers and the accumulate 746, and comparing the accumulated digit-wise residue value and the accumulated residue value to determine whether the converting the one or more hexadecimal integers and the accumulate are operating correctly 748.

Accuracy checking, in one or more aspects, may be performed on each loop and ensures proper processing.

In one aspect, referring to FIG. 7C, hardware device 700 includes at least one checking component 750 (e.g., residue component 350) to perform accuracy checking to determine whether the multiply is operating correctly 752. The accuracy checking includes, for instance, generating a residue value of the integer part and the fraction part 754, subtracting a calculated residue of the integer part from the residue value to obtain an intermediate residue value 756, multiplying the intermediate residue value by a select residue value to obtain a product 758, multiplying the fraction part by the select value to obtain an intermediate fraction value 760, generating another residue value of a next input, the next input being based on the intermediate fraction value 762, and comparing the product with the other residue value to determine whether the multiply is operating correctly 764.

In one aspect, the other part of the input value is split into multiple parts 766, and the performing the one or more arithmetic operations is performed on the multiple parts 768. The multiple parts include a fraction part and at least one correction part, the at least one correction part to be used to provide the converted result 770.

By splitting the fraction part, the input value fits the data path, such that the width of the data path need not be increased, avoiding an increase in costs.

In one aspect, the converting and the performing are repeated one or more times on one or more next input values to provide the converted result 772. A next input value of the one or more next input values are provided based on the performing the one or more arithmetic operations on at least the fraction part of the multiple parts of a previous input value 774.

In one aspect, referring to FIG. 7D, multiplication component 724 includes a feedback path to accumulate one or more correction terms obtained from performing the one or more arithmetic operations on one or more correction parts 776. The multiplication component includes, for instance, a multiplication tree with the feedback path 778. The multiplication tree is to multiply a plurality of correction parts with a select value to provide a plurality of correction terms and to accumulate the plurality of correction terms 780.

By using the multiplication component to multiply the correction terms, additional multiplier cycles are not needed. Further, by using the existing feedback path to perform the accumulation of the correction terms, no additional staging is necessary, providing flexibility.

As an example, the performing the one or more arithmetic operations includes performing a multiply of each multiple part by a select value 782. Further, at least one checking component 784 (e.g., residue component 350) is to perform accuracy checking to determine whether the multiply is operating correctly 786. By performing accuracy checking, proper processing is ensured.

By using the hardware device to perform the plurality of operations as part of executing an instruction, performance is improved, and use of system resources is reduced. In one aspect, the input value is converted directly from the one format to the other format within one instruction. That is, the value is converted without use of other instructions (e.g., architected instructions at the hardware/software interface), including other convert instructions to convert the value into intermediate formats prior to the final format.

Further, in one or more aspects, the hardware device may be used for other processing, such as binary integer to decimal integer conversion, thereby reducing the use of hardware components, reducing costs, and increasing flexibility.

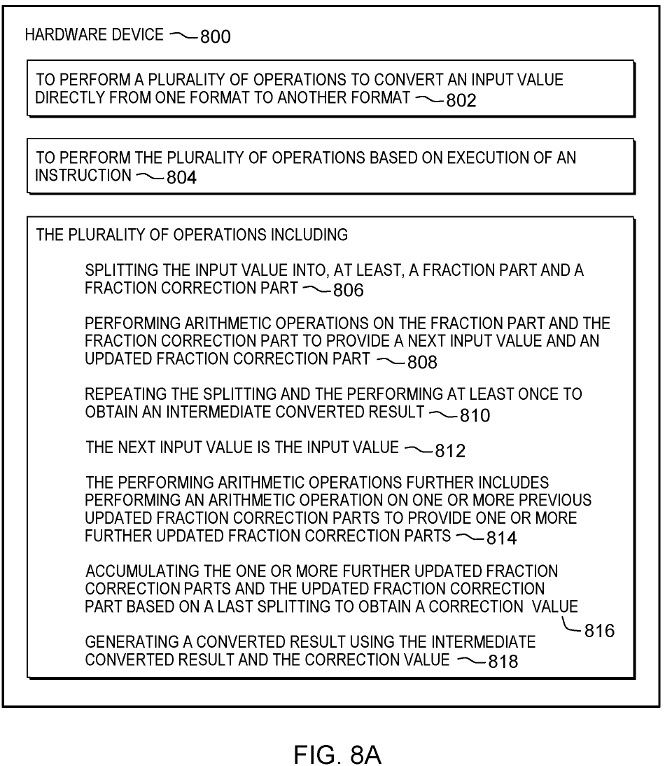

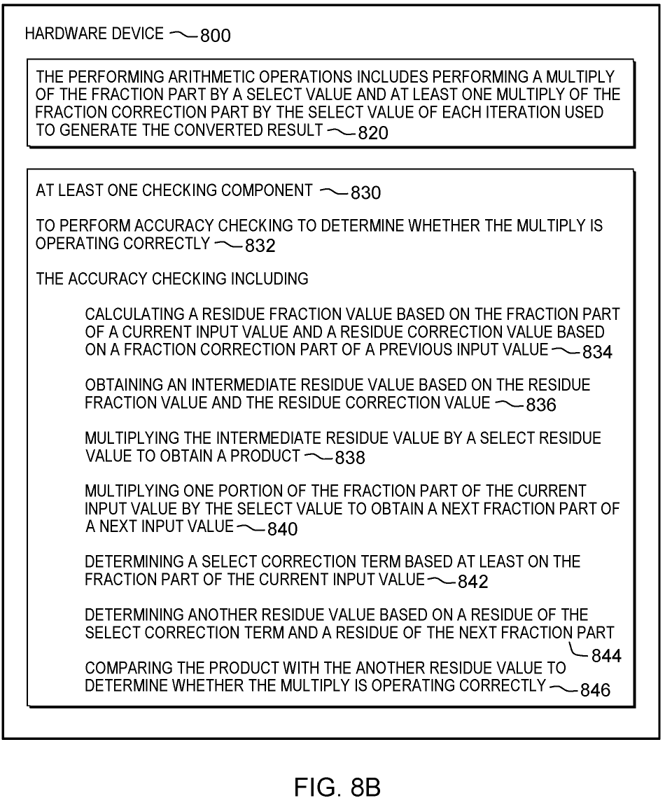

In one aspect, referring to FIG. 8A, a hardware device 800 (e.g., hexadecimal floating point unit 107) is to perform a plurality of operations to convert an input value directly from one format to another format 802. The plurality of operations is performed, e.g., based on execution of an instruction 804. The plurality of operations includes, for instance, splitting the input value into, at least, a fraction part and a fraction correction part 806, and performing arithmetic operations on the fraction part and the fraction correction part to provide a next input value and an updated fraction correction part 808. The splitting and the performing are repeated at least once to obtain an intermediate converted result 810, in which the next input value is the input value 812, and the performing arithmetic operations further includes performing an arithmetic operation on one or more previous updated fraction correction parts to provide one or more further updated fraction correction parts 814. The one or more further updated fraction correction parts and the updated fraction correction part based on a last splitting are accumulated to obtain a correction value 816. A converted result is generated using the intermediate converted result and the correction value 818.

By splitting the fraction part, the input value fits the data path, such that the width of the data path need not be increased, avoiding an increase in costs.

In one example, referring to FIG. 8B, the performing arithmetic operations includes performing a multiply of the fraction part by a select value and at least one multiply of the fraction correction part by the select value of each iteration used to generate the converted result 820.

Further, in one aspect, at least one checking component 830 of the hardware device (e.g., residue component 350) is to perform accuracy checking to determine whether the multiply is operating correctly 832. The accuracy checking includes, for instance, calculating a residue fraction value based on the fraction part of a current input value and a residue correction value based on a fraction correction part of a previous input value 834, obtaining an intermediate residue value based on the residue fraction value and the residue correction value 836, multiplying the intermediate residue value by a select residue value to obtain a product 838, multiplying one portion of the fraction part of the current input value by the select value to obtain a next fraction part of a next input value 840, determining a select correction term based at least on the fraction part of the current input value 842, determining another residue value based on a residue of the select correction term and a residue of the next fraction part 844, and comparing the product with the another residue value to determine whether the multiply is operating correctly 846.

Accuracy checking, in one or more aspects, may be performed on each loop and ensures proper processing.

By using the hardware device to perform the plurality of operations as part of executing an instruction, performance is improved, and use of system resources is reduced. In one aspect, the input value is converted directly from the one format to the other format within one instruction. That is, the value is converted without use of other instructions (e.g., architected instructions at the hardware/software interface), including other convert instructions to convert the value into intermediate formats prior to the final format.

Although embodiments are described herein, other variations and/or embodiments are possible.

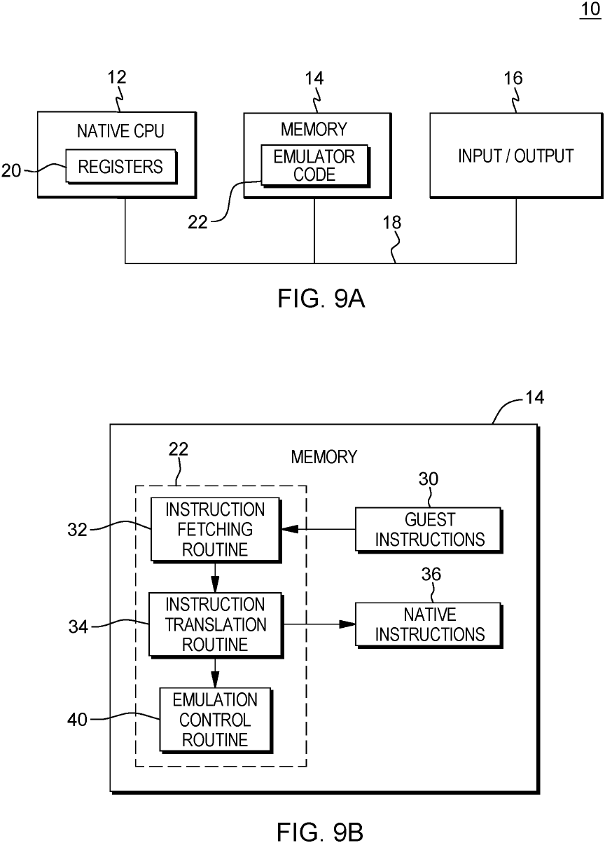

Aspects of the present invention and/or results provided by one or more aspects of the present invention may be used by many types of computing environments. Another example of a computing environment to incorporate and use one or more aspects of the present invention and/or to execute transactions that use results of one or more aspects of the present invention is described with reference to FIG. 9A. In this example, a computing environment 10 includes, for instance, a native central processing unit (CPU) 12, a memory 14, and one or more input/output devices and/or interfaces 16 coupled to one another via, for example, one or more buses 18 and/or other connections. As examples, computing environment 10 may include an IBM® Power® processor offered by International Business Machines Corporation, Armonk, New York; an HP Superdome with Intel® processors offered by Hewlett Packard Co., Palo Alto, California; and/or other machines based on architectures offered by International Business Machines Corporation, Hewlett Packard, Intel Corporation, Oracle, or others. Power is a trademark or registered trademark of International Business Machines Corporation in at least one jurisdiction. Intel is a trademark or registered trademark of Intel Corporation or its subsidiaries in the United States and other countries.

Native central processing unit 12 includes one or more native registers 20, such as one or more general purpose registers and/or one or more special purpose registers used during processing within the environment. These registers include information that represents the state of the environment at any particular point in time.

Moreover, native central processing unit 12 executes instructions and code that are stored in memory 14. In one particular example, the central processing unit executes emulator code 22 stored in memory 14. This code enables the computing environment configured in one architecture to emulate another architecture. For instance, emulator code 22 allows machines based on architectures other than, e.g., the IBM® z/Architecture® instruction set architecture, such as Power processors, HP Superdome servers or others, to emulate the z/Architecture instruction set architecture and to execute software and instructions developed based on the z/Architecture instruction set architecture.

Further details relating to emulator code 22 are described with reference to FIG. 9B. Guest instructions 30 stored in memory 14 comprise software instructions (e.g., correlating to machine instructions) that were developed to be executed in an architecture other than that of native CPU 12. For example, guest instructions 30 may have been designed to execute on a processor based on the z/Architecture instruction set architecture, but instead, are being emulated on native CPU 12, which may be, for example, an Intel processor. In one example, emulator code 22 includes an instruction fetching routine 32 to obtain one or more guest instructions 30 from memory 14, and to optionally provide local buffering for the instructions obtained. It also includes an instruction translation routine 34 to determine the type of guest instruction that has been obtained and to translate the guest instruction into one or more corresponding native instructions 36. This translation includes, for instance, identifying the function to be performed by the guest instruction and choosing the native instruction(s) to perform that function.

Further, emulator code 22 includes an emulation control routine 40 to cause the native instructions to be executed. Emulation control routine 40 may cause native CPU 12 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 36 may include loading data into a register from memory 14; storing data back to memory from a register; or performing some type of arithmetic or logic operation, as determined by the translation routine.

Each routine is, for instance, implemented in software, which is stored in memory and executed by native central processing unit 12. In other examples, one or more of the routines or operations are implemented in firmware, hardware, software or some combination thereof. The registers of the emulated processor may be emulated using registers 20 of the native CPU or by using locations in memory 14. In embodiments, guest instructions 30, native instructions 36 and emulator code 22 may reside in the same memory or may be disbursed among different memory devices.

The computing environments described above are only examples of computing environments that can be used. Other environments, including but not limited to, non-partitioned environments, partitioned environments, cloud environments and/or emulated environments, may be used; embodiments are not limited to any one environment. Although various examples of computing environments are described herein, one or more aspects of the present invention may be used with many types of environments. The computing environments provided herein are only examples.

Each computing environment is capable of being configured to include one or more aspects of the present invention. For instance, each may be configured to perform conversion of one data format to another data format, to execute transactions that use results of the conversion, and/or perform one or more other aspects of the present invention.

Although various embodiments are described herein, many variations and other embodiments are possible without departing from a spirit of aspects of the present invention. It should be noted that, unless otherwise inconsistent, each aspect or feature described herein, and variants thereof, may be combinable with any other aspect or feature.

One or more aspects may relate to cloud computing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

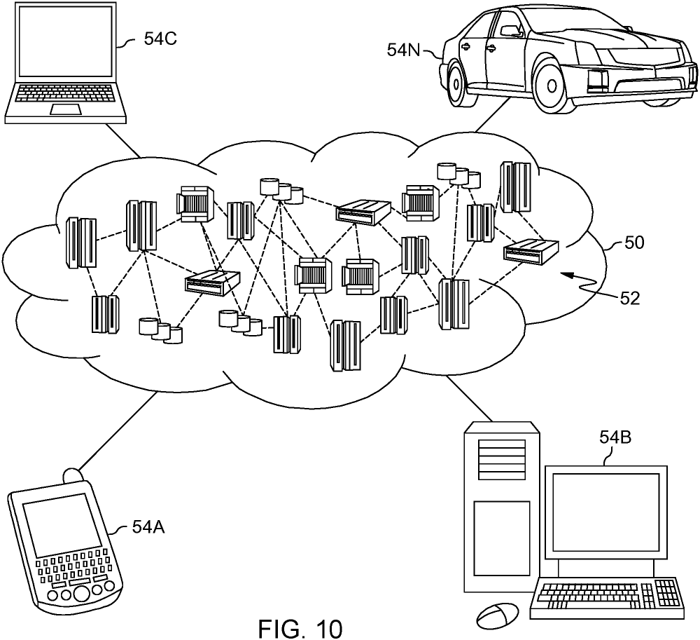

Referring now to FIG. 10, illustrative cloud computing environment 50 is depicted. As shown, cloud computing environment 50 includes one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 52 and cloud computing environment 50 can communicate with any type of computerized device over any type of network and/or network addressable connection (e.g., using a web browser).

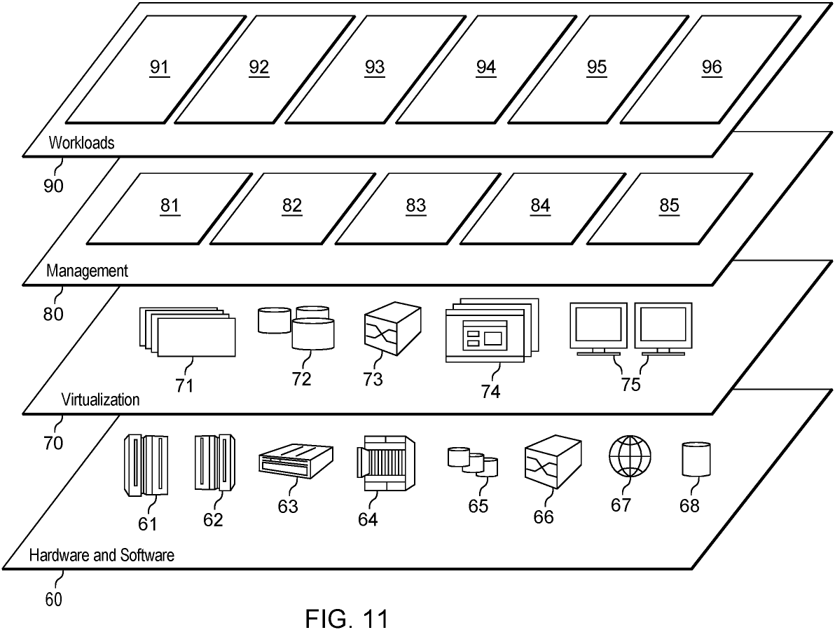

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and conversion processing 96.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, different components of a hardware device and/or other hardware devices may be used. Further, other data formats may be represented. Many variations are possible.

Various aspects are described herein. Further, many variations are possible without departing from a spirit of aspects of the present invention. It should be noted that, unless otherwise inconsistent, each aspect or feature described herein, and variants thereof, may be combinable with any other aspect or feature.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer system for facilitating processing within a computing environment, the computer system comprising:
a hardware device to perform a plurality of operations to convert an input value directly from one format to another format, the hardware device to perform the plurality of operations based on execution of an instruction, the plurality of operations comprising:
converting one part of the input value to provide a converted value;
performing one or more arithmetic operations on another part of the input value to provide an intermediate value; and
using the converted value and the intermediate value to provide a converted result in the another format, wherein the converting, the performing the one or more arithmetic operations and the using are performed as part of executing the instruction; and
wherein the hardware device is to provide the converted result in the another format to be used in processing within the computing environment.

2. The computer system of claim 1, wherein the converting and the performing are repeated one or more times on one or more next input values to provide the converted result, a next input value of the one or more next input values being provided based on the performing the one or more arithmetic operations on the another part of a previous input value.

3. The computer system of claim 1, wherein the one format is a hexadecimal floating point format and the another format is a binary coded decimal format, and wherein the one part of the input value is an integer part of the input value and the another part of the input value is a fraction part of the input value.

4. The computer system of claim 3, wherein the hardware device comprises a multiplication component, the multiplication component to multiply the fraction part by a select value to provide the intermediate value, the multiply being an arithmetic operation of the one or more arithmetic operations performed on the another part of the input value.

5. The computer system of claim 4, wherein the hardware device comprises at least one component to perform the converting the one part, the converting comprising converting one or more hexadecimal integers of the input value to one or more decimal integers, and to accumulate the one or more decimal integers, and wherein the multiply, the converting the one or more hexadecimal integers and the accumulate are performed at least substantially in parallel.

6. The computer system of claim 4, wherein the hardware device comprises at least one checking component to perform accuracy checking to determine whether the multiply is operating correctly.

7. The computer system of claim 6, wherein the accuracy checking comprises:
generating a residue value of the integer part and the fraction part;
subtracting a calculated residue of the integer part from the residue value to obtain an intermediate residue value;
multiplying the intermediate residue value by a select residue value to obtain a product;
multiplying the fraction part by the select value to obtain an intermediate fraction value;
generating another residue value of a next input, the next input being based on the intermediate fraction value; and
comparing the product with the another residue value to determine whether the multiply is operating correctly.

8. The computer system of claim 1, wherein the hardware device comprises at least one component to perform the converting the one part, the converting comprising converting one or more hexadecimal integers of the input value to one or more decimal integers, and to accumulate the one or more decimal integers, and wherein the hardware device further comprises at least one checking component to perform accuracy checking to determine whether the converting the one or more hexadecimal integers and the accumulate are operating correctly.

9. The computer system of claim 8, wherein the accuracy checking comprises:
generating a digit-wise residue of one or more converted digits of the one or more hexadecimal integers and accumulating digit-wise residues to obtain an accumulated digit-wise residue value;
calculating an accumulated residue value based on the one or more decimal integers obtained using the converting the one or more hexadecimal integers and the accumulate; and
comparing the accumulated digit-wise residue value and the accumulated residue value to determine whether the converting the one or more hexadecimal integers and the accumulate are operating correctly.

10. The computer system of claim 1, wherein the another part of the input value is split into multiple parts, and wherein the performing the one or more arithmetic operations is performed on the multiple parts, the multiple parts including a fraction part and at least one correction part, the at least one correction part to be used to provide the converted result.

11. The computer system of claim 10, wherein the converting and the performing are repeated one or more times on one or more next input values to provide the converted result, a next input value of the one or more next input values being provided based on the performing the one or more arithmetic operations on at least the fraction part of the multiple parts of a previous input value, and wherein the hardware device comprises a multiplication component, the multiplication component comprising a feedback path to accumulate one or more correction terms obtained from performing the one or more arithmetic operations on one or more correction parts.

12. The computer system of claim 11, wherein the multiplication component comprises a multiplication tree with the feedback path, the multiplication tree to multiply a plurality of correction parts with a select value to provide a plurality of correction terms and to accumulate the plurality of correction terms.

13. The computer system of claim 10, wherein the performing the one or more arithmetic operations includes performing a multiply of each multiple part by a select value, and wherein the hardware device comprises at least one checking component to perform accuracy checking to determine whether the multiply is operating correctly.

14. A computer system for facilitating processing within a computing environment, the computer system comprising:
a hardware device to perform a plurality of operations to convert an input value directly from one format to another format, the hardware device to perform the plurality of operations based on execution of an instruction, the plurality of operations comprising:
splitting the input value into, at least, a fraction part and a fraction correction part;
performing arithmetic operations on the fraction part and the fraction correction part to provide a next input value and an updated fraction correction part;
repeating the splitting and the performing at least once to obtain an intermediate converted result, wherein the next input value is the input value, and wherein the performing arithmetic operations further includes performing an arithmetic operation on one or more previous updated fraction correction parts to provide one or more further updated fraction correction parts;
accumulating the one or more further updated fraction correction parts and the updated fraction correction part based on a last splitting to obtain a correction value; and
generating a converted result using the intermediate converted result and the correction value.

15. The computer system of claim 14, wherein the performing arithmetic operations includes performing a multiply of the fraction part by a select value and at least one multiply of the fraction correction part by the select value of each iteration used to generate the converted result, and wherein the hardware device comprises at least one checking component to perform accuracy checking to determine whether the multiply is operating correctly, the accuracy checking comprising:
calculating a residue fraction value based on the fraction part of a current input value and a residue correction value based on a fraction correction part of a previous input value;
obtaining an intermediate residue value based on the residue fraction value and the residue correction value;
multiplying the intermediate residue value by a select residue value to obtain a product;
multiplying one portion of the fraction part of the current input value by the select value to obtain a next fraction part of a next input value;
determining a select correction term based at least on the fraction part of the current input value;
determining another residue value based on a residue of the select correction term and a residue of the next fraction part; and
comparing the product with the another residue value to determine whether the multiply is operating correctly.

16. A computer-implemented method of facilitating processing within a computing environment, the computer-implemented method comprising:
performing, by a hardware device of the computing environment, a plurality of operations to convert an input value directly from one format to another format, the hardware device to perform the plurality of operations based on execution of an instruction, the plurality of operations comprising:
converting one part of the input value to provide a converted value;
performing one or more arithmetic operations on another part of the input value to provide an intermediate value; and
using the converted value and the intermediate value to provide a converted result in the another format, wherein the converting, the performing the one or more arithmetic operations and the using are performed as part of executing the instruction; and
providing the converted result in the another format to be used in processing within the computing environment.

17. The computer-implemented method of claim 16, wherein the converting and the performing are repeated one or more times on one or more next input values to provide the converted result, a next input value of the one or more next input values being provided based on the performing the one or more arithmetic operations on the another part of a previous input value.

18. The computer-implemented method of claim 16, wherein the one or more arithmetic operations includes one or more multiply operations, and wherein the method further comprises performing accuracy checking to determine whether the one or more multiply operations are operating correctly.

19. The computer-implemented method of claim 16, wherein the method further comprises performing accuracy checking to determine whether the converting is operating correctly.

20. The computer-implemented method of claim 16, wherein the another part of the input value is split into multiple parts, and wherein the performing the one or more arithmetic operations is performed on the multiple parts.
